(19) United States
(12) Patent Application Publication
(10) Pub. No.: US 2025/0260680 A1
(43) Pub. Date: Aug. 14, 2025

(54) Multi-Person, Multi-Factor Authentication Systems, Methods, And Products

(71) Applicant: Timothy William Edgin, Houston, TX (US)

(72) Inventor: Timothy William Edgin, Houston, TX (US)

(21) Appl. No.: 18/438,428

(22) Filed: Feb. 10, 2024

(51) Int. Cl. H04L 9/40; H04L 9/00

(52) U.S. Cl. CPC H04L 63/08; H04L 9/50

(57) ABSTRACT

Systems, methods and products for multi-person, multi-factor authentication of users seeking access to resources is provided that use at least one authentication factor and voting over secure blockchain distributed ledgers with Smart Contracts and artificial intelligence to determine whether access should be authorized.

### FIELD OF THE INVENTION

The invention relates to the authentication of users to gain access to resources (e.g., applications, online accounts, digital currency, transactions, cryptocurrencies, VPNs, company systems).

### BACKGROUND OF THE INVENTION

The reliable authentication of users to gain access to a resource is important to improve the use of such resources and to decrease the likelihood of successful cyber-attacks. This is especially true for applications such as remote workers gaining access to a company's systems, applications, and data. It is also true for many other applications (e.g., on line bank account access). Improved systems and methods are needed for more reliable authentication of users.

### SUMMARY OF THE INVENTION

Certain embodiments of this invention provide systems, methods, and products for poly-person, poly-factor authentication that is an improvement and otherwise superior to multi-factor authentication (“MFA”, which requires a user (defined herein to include a person and/or a device) to provide at least one authentication factor (e.g., one-time passwords, thumbprint, physical hardware key) to obtain authentication and gain access to a resource such as an application, online account, digital currency, transactions, cryptocurrencies, VPN, company system, etc.). The systems and methods of this invention use voting over secure blockchain via Smart Contracts and require consensus (e.g., complete or a threshold amount of votes) to authenticate users. In certain preferred embodiments, when a user logs on to a resource (e.g., a system), a vote on a blockchain is triggered and a number of people (i.e., blockchain nodes) must vote to approve the log on. The votes happen over secure blockchain in combination with traditional authentication factors (e.g., phone, MFA tokens). In certain embodiments, decisions are aided by artificial intelligence (“AI”). The voting may be all persons doing the voting, all AI doing the voting, or a mix of persons and AI doing the voting.

Preferred embodiments of this invention include a system for authentication of a user logging on to a computer application. These embodiments of the systems comprise a secure blockchain that uses Smart Contracts and at least one authentication factor (e.g., phone number). In these embodiments, a consensus of votes is required to authenticate the user, and the votes are determined by persons, artificial intelligence, or a combination of persons and artificial intelligence using the Smart Contracts and the authentication factor. In these systems, certain embodiments further comprise AI that learns what authentication factors to apply to the user and when to apply them to increase the accuracy and reliability of the authentication. These authentication factors may be applied before the authentication is applied to the user, during the authentication, or even after the user is granted access if the AI triggers a potential issue (e.g., the user is using the computer application in different ways than expected (e.g., downloading large amounts of information, reviewing data that is not part of the person's duties)).

Preferred embodiments of this invention also include methods for authentication of a user logging on to a computer application (e.g., a company's internal network, an on line bank account). The methods comprise (a) comparing Smart Contracts on a secure blockchain associated with the user with information from the user's logging on to the computer application; (b) comparing at least one authentication factor for the user (e.g., phone number) with the user's logging on to the computer application; (d) determining whether there is a consensus (e.g., complete or a threshold number) of votes by persons, AI, or a combination of persons and AI using the comparison from the Smart Contracts and comparison with the authentication factor that are in favor of granting the user access to the computer application; and (e) granting or denying access to the computer application to the user based on whether there is a consensus of votes favoring granting the user access. Certain of these preferred embodiments further comprise using AI to determine what authentication factors to apply to the user and when to apply them to increase the accuracy and the reliability of the authentication.

Preferred embodiments of this invention also include an authentication computer program product for authenticating the rights of a user who has at least one authentication factor associated with the user to access a resource (e.g., computer application) after the user has made an authentication request (e.g., tried to log on to a system). The product is for execution on a device that is connected (or connectable) to a blockchain distributed network and AI. The product also comprises computer readable instructions that include the capability to: (a) receive and process the authentication request from the user to log on to a resource, wherein the authentication request comprises information concerning the user and the authentication factor from the user; (b) compare the authentication request with Smart Contracts on the blockchain distributed network; (c) compare the authentication request with the authentication factor from the user; (d) determine whether there is a consensus (e.g., complete or a threshold number) of votes by blockchain nodes, AI, or a combination of blockchain nodes and AI using the comparison from the Smart Contracts and comparison with the authentication factor that are in favor of granting the user access to the computer application; and (e) grant or deny the user access to the resource based on whether there is a consensus of votes in favor of granting the user access to the resource.

Applications for the embodiments of this invention include improving the authentication accuracy and experience of a user logging on to a system and other authentication and verification uses. The person of skill in the art understands how this application and combining of this invention can be done with additional applications requiring authentication and/or verification. Applications of this invention include but are not limited to financial transactions, supply chain records, company internal systems, healthcare, cybersecurity, and personal identity, among others.

Advantages of the embodiments of this invention are described and apparent throughout this specification. For example, certain embodiments will enhance a resource's security by ensuring that users are reliably authenticated. Previous techniques for MFA included usernames and passwords, but these are vulnerable to brute force attacks and can be stolen by third parties. Certain embodiments of this invention solve this problem and they are not vulnerable, or as vulnerable, to such brute force attacks.

This invention provides excellent data security and integrity due to its decentralized architecture. Blockchain hashing technology stores information securely on its ledger. This invention lacks or removes critical points of attack for hacking and entering into systems, reducing database breach threats. Furthermore, because identities are decentralized on the blockchain ledger, the blockchain gives its end users more control over their digital identities. Fraud is difficult to apply to blockchain networks because of the immutability it provides and the lack of the ability to tamper with data. The blockchain aspects of this invention also allow transactions between multiple parties without the involvement of third parties and the sensitive information is kept on multiple nodes on the network instead of being kept in one centralized database that is more sensitive to tampering. The use of AI with certain embodiments further enhances the advantages of this invention, increasing the reliability of the authentication and its usability by learning what factors to apply in different situations and enhances the detection and response to threats. Further advantages will be apparent to a person of skill in the art applying the embodiments of the invention.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a flowchart showing exemplary components and information flows of certain preferred embodiments of this invention.

### DETAILED DESCRIPTION OF THE INVENTION

Authentication is central to improving and maintaining cybersecurity. Cybercriminals constantly evolve to work around MFA and other security systems. The use of voting over secure blockchain via Smart Contracts by embodiments of this invention, which requires consensus (e.g., complete or a threshold number) to authenticate users, improves the security of systems. In addition, AI as provided by embodiments of this invention provides further strength and usability to security systems and methods. The use of AI as provided by embodiments of this invention may also cause minimal disruptions for legitimate users that need access.

The use of voting over secure blockchain via Smart Contracts in embodiments of this invention provides improved security over MFA alone. Blockchain is a distributed ledger system that records and stores data securely and reliability. It is also decentralized, storing the data on many computers (e.g., nodes) rather than a single, central computer, making it virtually impossible or at least highly difficult to tamper with or manipulate. Blockchain is highly fraud proof because it stores information in blocks that each have their own hash. Each hash is like a digital fingerprint of each block that acts as a unique identifier for the block. In addition, blockchain is faster than traditional systems.

Blockchain as used herein implements an immutable, transparent, and efficient system that cannot be readily hacked. Blockchain in essence is a shared database where the blocks cannot be changed or deleted across its many interconnected nodes in a distributed network. Blockchain does not use a centralized approach to control the network, increasing security.

In particular, the blockchain of this invention verifies a user's “transaction” or login attempt within a network. It uses blockchain's distributed ledger technology and authentication to enhance the authentication process. The user's personal information that is used to verify the user's identity is stored on the block's hash, such as a username or password, helping to achieve a self-sovereign identity. The login or other transaction is signed using a private key and broadcast across the network. The network nodes validate the transaction using the corresponding public key, applying hashing to ensure that the data has not been tampered with.

Thus, as used herein, blockchain offers enhanced transparency, accessibility and tamper-proof technology for authentication. Particular blockchain can be used, such as Ethereum, as the underlying blockchain platform, while Smart Contracts are used to record and validate the votes.

In particular, Smart Contracts are simple logical bits of programs stored on each block of blockchain that run when certain conditions are met. Smart Contracts follow “if/when . . . then . . . ” statements written on the blockchain and help automate the verification involved with authentication. The automatic execution of the requirements ensure the outcome is correct and the irreversibility and traceability of each transaction increases the trust in the outcome. Smart Contracts make faster and better decisions that save time, lower cost and lower risk.

The AI part of embodiments of this invention provides intensive and sophisticated processing of authentication data in real-time. For example, if a user tries to log into a system from New York City, then five minutes later attempts to log in from Moscow, AI can be used to identify the problem of a person appearing to be in two places at once.

The AI assesses and weighs individual factors from the login attempt and creates a risk score. If the score is too high, the AI may be used to deny the user access altogether. If the score is lower, the AI may suggest additional factors for the user to provide before access is granted. Some scores can be determined to justify providing the user immediate access.

In certain embodiments, the AI monitors and collects a number of factors concerning a user and the user's past login attempts and builds a profile for the user. These factors can include the user's location, the user's network and its reliability, the user's device, the time of login, etc. When faced with a new login attempt by someone who appears to be the user, the AI can compare that new login attempt with previous attempts and the profile the AI created or was provided. If the comparison shows too much variability, the login attempt may be denied outright. With less variability, the AI may request additional authentication information from the user before access is granted. With even less variability, the AI may grant immediate access.

The AI-powered authentication can identify low-risk users and make their login attempts faster and less obtrusive. The AI can also identify high-risk users and login attempts and only then slow down the process and collect additional authentication factors, making the authentication process more rational and less intrusive when it can be.

The more it is used, the more the AI can protect the system without slowing users down. At first, the AI may just compare a few factors, but as it collects more information, using unsupervised learning it may find new patterns to use to make increasingly good predictions. The AI may cross-reference different machine learning algorithms using pattern recognition and leverage time-based predictive algorithms to improve the accuracy and scope of its predictions.

The AI provides a record of what data went into a given decision and the number of factors that were considered and thus the system can be reviewed and tailored to, and refined by, the actual environment of the use. The AI can also use information from third parties concerning past threats and stolen credentials of particular users, and other such relevant information, all in real time, to evaluate risk.

Embodiments of this invention may include one or more AI configuration engines comprising computer readable code stored on a non-transitory computer-readable medium. This AI engine can automate processes on a blockchain distributed ledger. This AI in one or more engines, when executed by a computer system(s), may (1) operate or facilitate the processes on one or more nodes on a blockchain distributed ledger (e.g., AI models embedded in Smart Contracts executed on a blockchain), and/or (2) be used in the authentication process of this invention to ingest authentication factors and other information from or pertaining to users (e.g., log in information, query responses, patterns from past behavior, stored information on the user in a database), ingest the results of voting by nodes in a blockchain distributed ledger, optionally ingest AI or human feedback on authentication factors and the other information from users, and/or dynamically correlate authentication factors with voting results and any feedback results to train on, update and/or suggest which authentication factors and other information are likely to obtain which voting results.

Preferred embodiments of this invention include supervised and/or unsupervised

learning models using AI that that processes, trains on, updates, and/or suggests which authentication factors and other information from users (e.g., logging on information input from the user or the user's computer) or pertaining to users (e.g., from a database with data keyed to a user) is relevant to authentication of the users in obtaining access to resources such as computer applications. For example, a user's address or other attribute may be associated with a higher level of trust in authentication as learned by AI that informs the system.

Certain preferred embodiments of this invention use large language models (LLMs) types of AI algorithms that use deep learning techniques and can use large data sets to understand, operate (e.g., apply Smart Contracts), summarize, generate and predict new content. Particular transformer models are capable of generating accurate responses rapidly, for example.

The inputs of this information may be provided by the user using a computer device (e.g., mobile phone, laptop computer and keyboard, scanned driver's license, camera (e.g., facial recognition, fingerprint). The inputs may also come from a database of information pertaining to the user. The inputs may also come from or multiple sources (e.g., inputs and databases). The inputs are then uploaded to a cloud-based or other network based computer automatically by systems of these embodiments. The inputs are stored and processed in computer readable memory and processors that execute instructions, which may include Smart Contracts and other aspects of blockchain distributed ledgers. The outcome of the processing can be used by the blockchain in voting, Smart Contracts, and/or otherwise provided to a system or person for training, updating and/or modifying the system (e.g., on how to weigh authentication requirements and factors). Other inputs can be from instances when a user should not have been granted access, law enforcement, etc., and the authentication was faulty, and thus they can be used to train, update and/or modify the system. The AI can be used in supervised and unsupervised learning models in the manner set forth above to process large quantities of inputs and identify patterns in the inputs to predict anomalies and results.

User information (e.g., from logging on (e.g., the user's device, time, place)), from authentication factors provided by the user, or databases pertaining to the user, may be stored as database objects (DBOs). The DBOs may be arranged in a set of logical tables containing data fitted into predefined or customizable categories, and/or the DBOs may be arranged in a set of blockchains or ledgers wherein each block (or DBO) in the blockchain is linked to a previous block. Each of the DBOs may include data associated with individual users, such as biographic data collected from individual users; biometric data collected from individual users; data collected from various external sources; identity session identifiers (IDs); AI generated information; identity scores, survey assessment scores, etc.; and/or other like data. Some of the DBOs may store information pertaining to relationships between any of the data items discussed herein. Some of the DBOs may store permission or access-related information for each user. These DBOs may indicate specific third parties that are permitted to access identity data of a particular user. In some implementations, the permission or access-related DBOs for each user may be arranged or stored as a blockchain to control which third parties can access that user's identity data. In these embodiments, the blockchain(s) do not actually store user biometric and/or biographic data, but instead are used to authorize specific third party platforms to access specific identity data items and to track or account for the accesses to the identity data items.

The subject matter of this disclosure is now described with reference to the following examples. These examples are provided for the purpose of illustration only, and the subject matter is not limited to these examples, but rather encompasses all variations which are evident as a result of the teaching provided herein.

### EXAMPLE 1

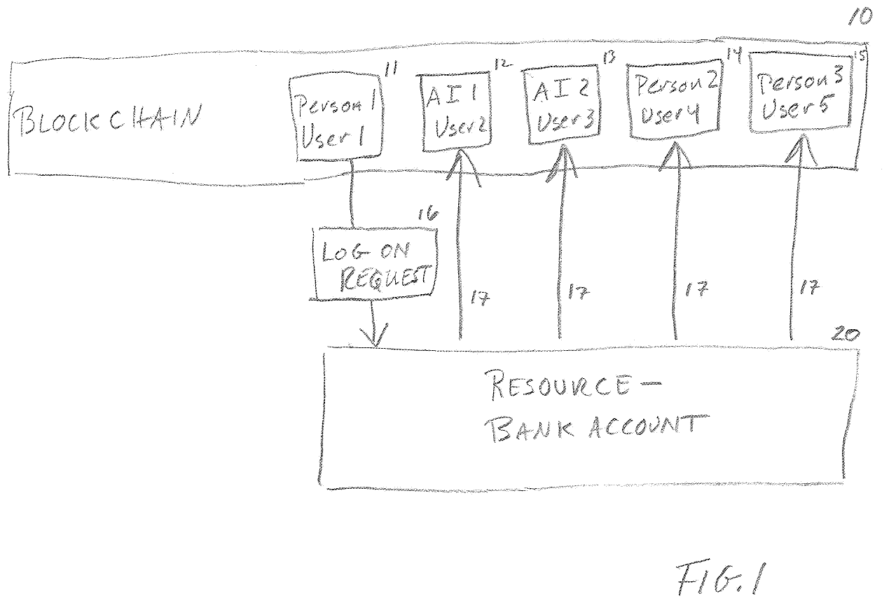

In the illustration of embodiments of this invention shown in part by FIG. 1, a blockchain distributed ledger 10 is used that is comprised of any number of users. FIG. 1 shows five users, three of which are humans (“Persons”) 11, 14, 15, and two of which are AI (e.g., LLM) 12, 13. When User 1 11 makes a log on request 16 to a resource 20, shown in FIG. 1 as a bank account, the request triggers 17 votes on the blockchain 10. A consensus of votes of all users (except User 1) or some threshold (e.g., at least three users besides User 1) is required to allow authentication of User 1 11 and the authorization of User 1 11 to have access to the resource 20. The user's votes may be determined by a mix of authentication factors provided by User 1 11 in the log on request 16, Smart Contracts in the blockchain 10, and/or other factors.

### Particular Applications to Computer Devices

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block

diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A system for authentication of users logging on to a computer application, the users each having at least one associated authentication factor, the system comprising:
communicative coupling to a secure blockchain with a plurality of nodes comprising persons, artificial intelligence, Smart Contracts and the authentication factor, which use a threshold number of votes from the nodes to authenticate the users; wherein the votes are determined by the persons, artificial intelligence, or a combination of persons and artificial intelligence using the Smart Contracts and the authentication factor; and wherein access to the computer application is granted or denied by the system based on whether there is the threshold of votes in favor of granting access to each of the users to the computer application.

2. The system of claim 1 further comprising artificial intelligence that learns what authentication factor to apply to the users and when to apply it to increase the accuracy and reliability of the authentication.

3. A method for authentication of a user logging on to a computer application, the user having at least one associated authentication factor, the method comprising:
a. comparing Smart Contracts on a secure blockchain associated with the user with information from the user's logging on to the computer application;
b. comparing the authentication factor for the user with the information from the user's logging on to the computer application; and
c. determining whether there is a threshold number of votes by persons, artificial intelligence, or a combination of persons and artificial intelligence using the comparison from the Smart Contracts and comparison with the authentication factor that are in favor of granting the user access to the computer application; and
d. granting or denying access based on whether there is the threshold of votes in favor of granting the user access to the computer application.

4. The method of claim 3 further comprising teaching the artificial intelligence what authentication factors to apply to the user and when to apply them to increase the accuracy and the reliability of the authentication.

5. An authentication computer program product for authenticating the rights of a user who has at least one authentication factor associated with the user to access a resource after the user has made an authentication request, and for execution on a device that is communicatively coupled to a blockchain distributed network and artificial intelligence, the authentication computer program product comprising computer readable instructions, the instructions comprising the capability to:
a. receive and process the authentication request from the user to log on to a resource, wherein the authentication request comprises information concerning the user and the authentication factor from the user;
b. compare the authentication request with Smart Contracts on the blockchain distributed network;
c. compare the authentication request with the authentication factor from the user;
d. determine whether there is a threshold number of votes that are in favor of granting the user access to the computer application by blockchain nodes comprising humans and/or artificial intelligence, using the comparison from the Smart Contracts and comparison with the authentication factor; and
e. grant or deny the user access to the resource based on whether there is the threshold number of votes in favor of granting the user access to the resource.
